(19) United States
(12) Patent Application Publication
(10) Pub. No.: US 2009/0231512 A1
(43) Pub. Date: Sep. 17, 2009

(54) DISPLAY AND REFLECTION BOARD

(75) Inventors: Tatsuo UCHIDA, Miyagi (JP); Takahiro ISHINABE, Miyagi (JP); Yoshito SUZUKI, Miyagi (JP); Keiji SAWANOBORI, Tokyo (JP)

Correspondence Address: GREENBLUM & BERNSTEIN, P.L.C., 1950 ROLAND CLARKE PLACE, RESTON, VA, 20191, US

(73) Assignees: TOHOKU UNIVERSITY, Miyagi (JP); HOYA CORPORATION, Tokyo (JP)

(21) Appl. No.: 12/403,476

(22) Filed: Mar. 13, 2009

(30) Foreign Application Priority Data
Mar. 14, 2008 (JP) 2008-065817

(51) Int. Cl. G02F 1/13357; G02F 1/01

(52) U.S. Cl. 349/63; 359/263

(57) ABSTRACT

A display is provided that comprises a reflection board and a display element. The reflection board includes a plurality of first inclinations and a plurality of second inclinations which are alternately arranged to form an uneven reflective surface to reflect and diffuse incident light. The display element has controllable transparency at each pixel and is disposed in front of the reflective surface. The mean inclination angle of the first inclination occurs within a range of 10 to 25 degrees.

### BACKGROUND OF THE INVENTION

1. Field of the Invention

The present invention relates to a display that is designed for outdoor use as well as for indoor use.

2. Description of the Related Art

A liquid crystal device controls the transparency of each pixel to generate contrast in order to produce images or patterns. Since the liquid crystal device is not luminous, it requires a light source to function as a display.

The transparent type of liquid crystal display is the most popular. In this type of device, a light source called a backlight is disposed behind the liquid crystal device (panel) and light from the backlight which passes through the liquid crystal device reveals the image on the di splay.

Since the transparent type liquid crystal display uses backlight illumination, it is suitable for indoor use where ambient light is not so strong. Therefore, this type of device is commonly used for computer displays and the like. However, this type has a disadvantage in visibility when ambient light is strong, such as in strong sunlight. So the liquid crystal display of the transparent type is not suited for displays used in mobile electronic devices intended to be used outdoors, such as in cellular phones. Moreover, the transparent type liquid crystal display is power-hungry, and therefore less suitable for mobile electronic devices.

On the other hand, there exists a reflective liquid crystal display that does not require a backlight and is better suited for outdoor use. FIG. 8 illustrates the configuration of a reflective liquid crystal display 100 from prior art. A reflection board 102 is disposed behind a liquid crystal device or panel 101 to reflect the light transmitted through the liquid crystal device 101. Namely, the light reflected by the reflection board 102 is used to display an image produced on the liquid crystal device 101.

FIG. 9 is an enlarged cross-sectional view of the reflection board 102 which illustrates the detailed structure of the prior art. As shown in FIG. 9, the surface of the reflection board 102 is unevenly formed. If the surface of the reflection board 102 were evenly formed, it would act as a mirror and reflect one's face when looking at the display 100. Therefore, the reflective surface of the reflection board 102 ideally should diffuse light, and for this reason, the surface of the reflection board 102 is made uneven.

As illustrated in FIG. 9, a depressed portion has surfaces 103 and 104 which are inclined at the same angle but opposite with respect to the normal line L of the reflection board 102.

With the above-mentioned reflective liquid crystal display 100, light its reflected more strongly by the reflection board 102, as the ambient light gets stronger, thus maintaining visibility of the liquid crystal display 100 even under strong ambient light, in contrast to the transparent type.

Furthermore, since the reflective type does not use a backlight, which consumes much electric power, the battery life of a mobile device is extended over the case of the transparent type. Therefore, the reflective liquid crystal display is suitable for mobile electronic devices used outdoors.

Note that there is also another type of display called the semi-transparent type. This type contains a backlight behind the reflection board and light from the backlight and reflection light are both used to reveal the image on the liquid crystal device.

### SUMMARY OF THE INVENTION

Although the reflective display, has improved outdoor visibility compared to the transparent type, visibility under strong ambient light, such as sunlight, is still less than ideal, and thus, further improvement is required.

Therefore, an object of the present invention is to provide a display with a reflection board that efficiently uses ambient light and which produces a bright image.

According to the present invention, a display is provided that comprises a reflection board and a display element. The reflection board includes a plurality of first inclinations and a plurality of second inclinations which are arranged alternately to form an uneven reflective surface to reflect and diffuse incident light. The display element controls the transparency of each pixel and is disposed in front of Hie reflective surface. The mean inclination angle of the first inclination being set within a range of 10 to 25 degrees.

According to another aspect of the present invention, a reflection board for a display is provided that comprises a plurality of first inclinations and a plurality of second inclinations. The first and second inclinations are arranged alternately to form an uneven reflective surface to reflect and diffuse incident light. The mean inclination angle of the first inclination is set within a range of 10 to 25 degrees.

### BRIEF DESCRIPTION OF THE DRAWINGS

The objects and advantages of the present invention will be better understood from the following description, with reference to the accompanying drawings in which:

FIG. 1 is a schematic cross-sectional view of the reflective liquid crystal display of the first embodiment;

FIG. 2 is an enlarged cross-sectional view of the reflection board depicting the uneven structure of the reflective surface;

FIG. 3 illustrates the inclination angle β;

FIG. 4 indicates the frequency distribution of the inclination angle β of the main reflecting inner surface in each depression;

FIG. 5 illustrates the profile of inner surfaces inside a depression, having the inclination angle β with frequency distribution as shown in FIG. 4;

FIG. 6 indicates the reflection property of the reflection board when light is made incident on the reflection board at 45 degrees;

FIG. 7 is a schematic cross-sectional view of the semi-transparent type liquid crystal display of the second embodiment;

FIG. 8 illustrates the configuration of a reflective liquid crystal display from prior art;

FIG. 9 is an enlarged cross-sectional view of the prior art reflection board illustrating the detailed structure of the reflection board surface; and

FIG. 10 schematically illustrates the problems inherent in a conventional reflective display.

### DESCRIPTION OF THE PREFERRED EMBODIMENTS

The present invention is described below with reference to the embodiments shown in the drawings.

First, the reason why the visibility of the prior art reflective liquid crystal display is limited when used outside is explained with reference to FIG. 10.

When the display 100 is used, the surface of the display 100 is generally slanted at an angle a (e.g., 45 degrees) from the horizontal in the vertical direction, as shown in FIG. 10. Furthermore, the user normally looks into the display 100 from a position right in front of the display 100. As discussed previously, the surface of the reflection board 102 is unevenly formed so that incident light is dispersed as shown in FIG. 10. Note that numeral 105 denotes the user's eye, line G is the normal line from the eye 105 to the front face of the display 100, and line H represents an ambient light beam, such as from sunlight, which is made incident on the display 100 from directly above. Light beams J are diffused ambient light beams, which diverge from ambient light H and are reflected at a position I where the normal line G meets the front face of the display 100. Reflected light beams J diverge within a certain angle range.

Specifically, when the incident ambient light H (particularly sunlight) is reflected, it is diffused within a certain range of angles with a specular light reflection direction at the center. The specular light reflection direction is substantially different from the normal line direction (line G) so that the diffusion range of the reflected light must be set very wide for the reflected light to reach the eye 105.

However, the extension of the diffusion range decreases the intensity of reflected light per unit solid angle. As a result, the brightness of the display is decreased and visibility deteriorates. Therefore, the efficiency of the prior art reflective display for use in ambient light is limited. This tendency increases as angle α, the angle of the display from the horizontal surface, increases.

With devices in which the direction of the display can be easily adjusted by the user, such as a cellular phone, the direction of the display may be changed by the user to afford greater visibility. However, in the case of a device whose screen is generally held vertically under normal usage, such as a digital camera, the above-mentioned angle α becomes large. In such case, it is clear that even the reflective display can not effectively use the ambient light H, such as sunlight, to display an image on the liquid crystal device. Due to this, the visibility of the reflective display does not improve even with increased ambient light.

The present invention takes advantage of the discovery that incident light on the display for the most part Strikes largely at an angle within approximately 40 to 50 degrees. Furthermore, the inventors discovered that sunlight could effectively be used as the display light by setting the angle of the principal direction of the diffusion of the reflected sunlight to be smaller than the incident angle of the incident sunlight.

In an embodiment of the present invention, a reflection board is configured, to have depressed portions where each of the cross-sectional profiles includes at least two inner surfaces and where the mean inclination angle of one of the inner surfaces that contributes more to reflect and diffuse the incident light is within a range of 10 to 25 degrees. The material of the reflection board may be aluminum (Al), silver (Ag), or an alloy including aluminum and/or silver. When this reflection board is applied in conjunction with a liquid crystal device, the reflection board may also provide electrodes for the liquid crystal display. The uneven surface of the reflection board may be formed through photolithography or injection molding.

As for the semi-transparent type display, a backlight is disposed on the opposite side of a display panel, such as the liquid crystal device, with the reflection board in between. The reflection board of the semi-transparent type has a reflective and trasmissive area for each pixel of the display. The reflective area may include aluminum (Al), silver (Ag), or an alloy including aluminum and/or silver while the transmissive area may include ITO (Indium Tin Oxide).

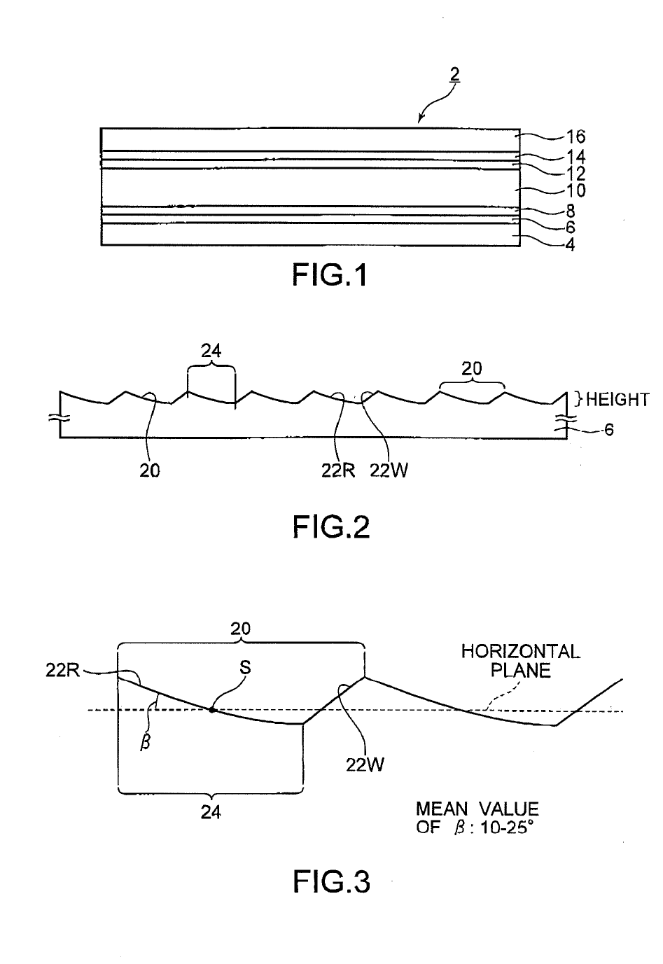

With reference to FIGS. 1-3, a reflective liquid crystal display of a first embodiment in which the present invention is applied is explained.

FIG. 1 is a schematic cross-sectional view of the reflective liquid crystal display of the first embodiment. In FIG. 1, the TFT drive circuit, color filter, polarizer, and optical filter are omitted. FIG. 2 is an enlarged cross-sectional view of a reflection board of the present embodiment depicting the uneven structure of its reflective surface. FIG. 3 illustrates the definition of inclination angle β.

The mean inclination angle in this application is explained with reference to FIG. 3.

(1) The inclination angle β at point S is defined as an angle from the horizontal plane of the reflection board at point S, where point S is any point on an inner surface 22R which corresponds to the main surface that contributes to diffusion reflection in one depression.
(2) The mean inclination angle is defined as the mean value of inclination angle β in area 24 (from the bottom to the top of the inner surface 22R).
(3) Note that inclination angles and their mean value for an inner surface 22W on the opposite side of the inner surface 22R, which hardly contributes to the reflection, can also be defined in the same way as the inner surface 22R. However, since the inclination of the inner surface 22W to the horizontal surface is opposite to that of the inner surface 22R, the signs of each inner surface are opposite.

Referring to FIG. 1, the schematic structure of the reflective liquid crystal display 2 of the present embodiment is explained. The reflective liquid crystal display 2 of the present embodiment is not a type having a reflection board outside a glass substrate, such as that implemented in a portable calculator, a cellular phone, a watch, or the like. The reflective liquid crystal display 2 of the present embodiment is of the type with the reflection board disposed inside the glass substrate.

When the reflection board is disposed outside the glass substrate, high resolution or color display can not be adequately achieved. For high resolution and/or color display, the reflection board must be disposed inside the glass substrate, adjacent to the liquid crystal. The reflection board of the present invention meets this requirement.

The glass substrate 4 is the bottom layer of the reflective liquid crystal display 2. The reflection board 6 of the present embodiment is attached to the glass substrate 4. The reflection board 6 may include or be made of aluminum (Al), silver (Ag), or an alloy including aluminum and/or silver. The reflection board 6 may also be provided with electrode patterns (not shown), and thus function as the lower-side electrode (not shown). Furthermore, the reflection board 6 has the uneven reflective surface described in FIG. 2, which will be detailed later.

Over the reflection board 6, a lower-side alignment film 8, a liquid crystal (display element) 10, an upper-side alignment film 12, a transparent electrode (the upper-side electrode) 14, and an upper-side glass substrate 16 are disposed, in this order. Furthermore, the transparent electrode may include indium tin oxide (ITO) or the like.

Details of the depression 20 formed on the reflective surface of the reflection board 6 are explained with reference to FIGS. 2 and 3.

The reflection board 6 has a plurality of depressions 20 regularly arranged in a predetermined direction. Namely, each depression 20 is defined by two neighboring apices of the reflective surfaces, in which the distance between the apices determines the pitch of the depressions 20. An example of the pitch is approximately 6-10 μm. Furthermore, the depth or the difference in height between the bottom and top of the depression 20, in other words, the height of the bump, is approximately 1-3 μm. The depressions 20 may be formed by injection molding. Note that the depressions 20 may also be formed by a known method other than injection molding, such as photolithography.

The reflective liquid crystal display 2 of the present embodiment may be provided on the back of a digital camera. The display 2 is held substantially in an upright position when the digital camera is at the ready under normal photographing conditions. In FIG. 2, the leftward direction o the drawing corresponds to the downward direction of the display 2 (the gravitational direction) and the rightward direction corresponds to the upward direction of the display 2. In FIG. 2, ambient light, such as sunlight, is made incident on the reflective surface of the reflection board 6 from the upright direction at an incident angle of 40 to 50 degrees. The inner surface (a first inclination) 22R of each depression 20, which faces upward, effectively contributes to the reflection and diffusion of the incident light. On the other hand, the inner surface (second inclination) 22W of each depression 20, which faces downward, does not contribute to the reflection and diffusion of the incident light.

As described in FIGS. 2 and 3, the inner surface 22R and the inner surface 22W are alternately arranged and the reflection board 6 has the reflective surface formed in a predetermined uneven pattern. The area of the inner surface 22R is larger than the area of the inner surface 22w. Furthermore, the inclination angle β of the inner surface 22R with respect to the horizontal plane of the display 2 is smaller than that of the inner surface 22W.

The inclination of the inner surface 22R is close to the horizontal plane of the display 2, such that the inclination angle of the inner surface 22 is comparatively small. On the other hand, the inclination of the inner surface 22W is close to the normal direction of the horizontal plane, such that the inclination angle of the inner surface 22W is comparatively large and could also be normal to the horizontal plane. Here, the horizontal plane of the display means the plane parallel to the screen of the liquid crystal display.

As previously mentioned, the mean inclination angle of the present embodiment, which is the mean value of the inclination angle α of the inner surface 22R, is set to within 10 to 25 degrees.

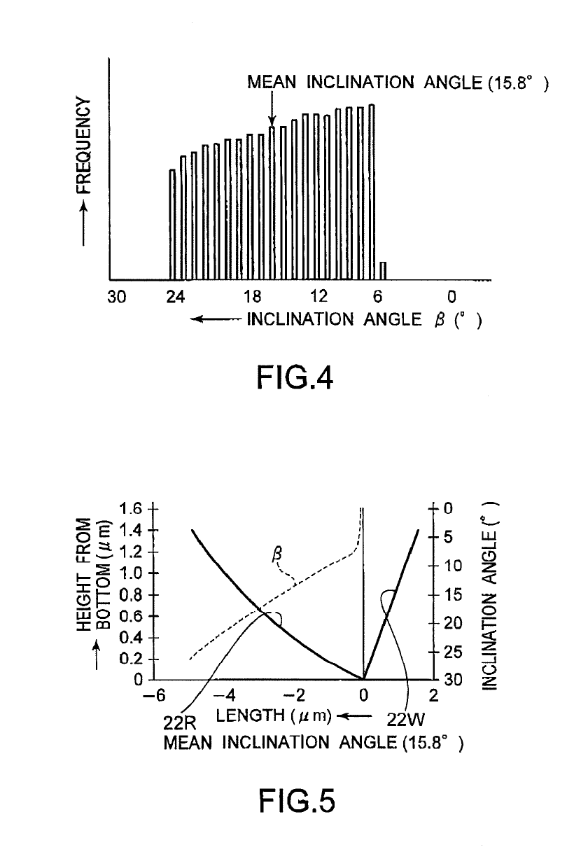

FIGS. 4 to 6 depict an example of the inventive reflection board, and respectively represent the frequency distribution of the inclination angles, the profile of the inner surface 22R and the inclination angles at each position, and the reflection properties of the reflection board.

As mentioned, FIG. 4 shows the frequency distribution of the inclination angles β of the inner surface 22R found in each of the depressions 20. The horizontal axis represents the inclination angle β. In this example, the inclination angle data was measured within the range Of 0 to 30 degrees with one-degree bins. The vertical axis represents the frequency of the inclination angles for each of bin.

In this example, the frequency was 0 for the bins from 0 to 5 degrees. At 6 degrees, a low frequency is found. The frequency abruptly increases at 7 degrees, the peak of the frequency distribution. Namely, the frequency gradually decreases as the inclination angle β increases from 7 to 24 degrees. Above 24 degrees frequencies are at zero. The mean inclination angle β of the inner surface 22R was found to be 15.8 degrees.

FIG. 5 illustrates the profile of inner surface 22R inside the depression 20 having the frequency distribution of the inclination angle β as shown in FIG. 4. Here, the horizontal axis represents length (in μm) in the cross-sectional direction of the depression and the vertical axis represents the height (also in μm) from the bottom of the depression. In FIG. 5r the solid line indicates the inner surface 22R (however, the profile of the inner surface 22W is also partially depicted as a solid line). Furthermore, the dashed line indicates the inclination angle β at each point.

The profile of the inner surface 22R shown in FIG. 5 provides the inner surface 22R of the depression 20 with the frequency distribution of the inclination angle β as shown in FIG. 4, and a mean inclination angle β of 15.8 degrees, satisfying the condition of 10-25 degrees.

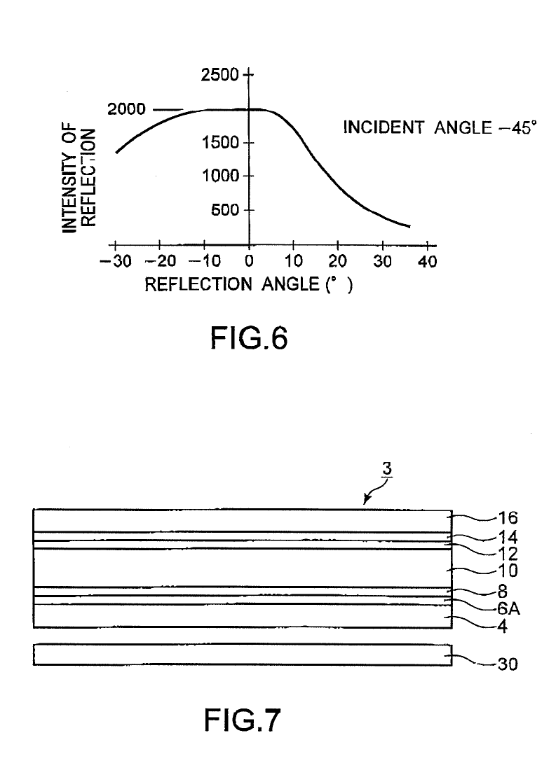

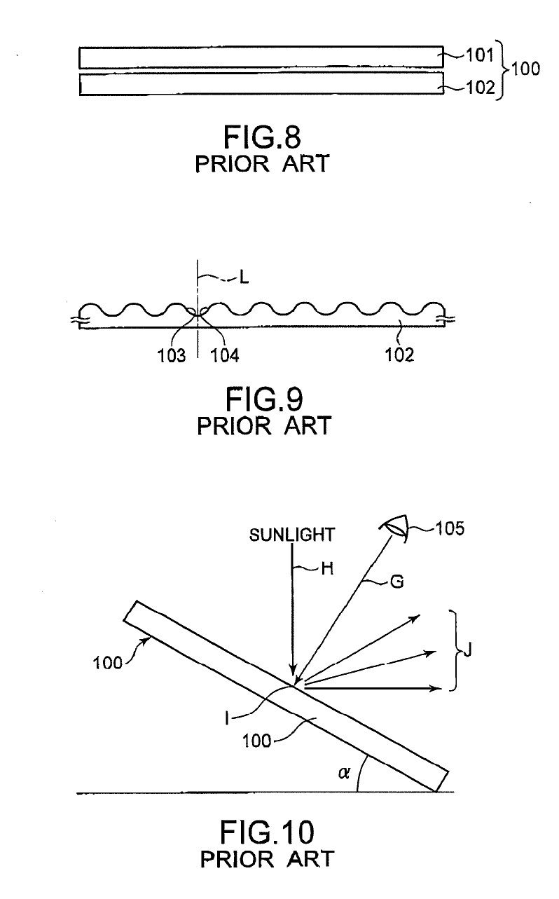

FIG. 6 indicates the reflection property of the reflection board when light is made incident on the reflection board at 45 degrees. The horizontal axis represents a reflection angle (°) and the vertical axis represents the intensity of the reflection or the reflection light. Here, the intensity is represented by non-dimensional relative values. Also, the maximum intensity is set to 2000. Note that the reflection angle is defined as the angle between the normal line of the horizontal plane of the reflection board (display) and the ray of reflected light. Furthermore, the signs of the incident angle and the reflection angle are defined as both of the angles in specular reflection being positive, thus, an incident angle of −α coincides with a reflection angle of +α and vise versa. In FIG. 6, the incident angle of sunlight is set to −45 degrees, i.e., +45 degrees in terms of the reflection angle.

When a mobile electronic device, such as a digital camera, is used under the sunlight, the ambient light is essentially made incident onto the display with incident angles between 40 and 50 degrees. Therefore, the reflection property indicated in FIG. 6 relies on the condition in which the incident angle is at 45 degrees, the midpoint between 40 and 50 degrees.

As shown in FIG. 6, although the incident angle is set at 45 degrees, the intensity of reflection has the peak about the normal direction of the horizontal plane (the direction where the reflection angle is 0 degrees). Therefore, the issues of the conventional reflection board that were previously discussed are resolved. Furthermore, in this example, the area with strong (e.g., maximum) intensity is extended to about +5 degrees. This means that the visibility of the display is also improved in the direction in which the ambient light is made incident. Namely, this is effective when the user looks into the display from the same direction in which the sunlight is made incident onto the display, such as when the sun is located at the upper rear side of the user.

The intensity of the light reflection is suitably distributed over a range of reflection angles by designing the inner surface (the reflection surface) 22R so as to include a curved surface, namely, a concave surface with a mean inclination angle within 10 to 25 degrees. More specifically, the range of the frequency distribution of the inclination angles β is extended appropriately, as shown in FIG. 4, with the mean inclination angle at the center, by forming a concave inner surface 22R, and thereby appropriately distributing the intensity of the light reflection. The distribution of the reflection peak is extended up to +5 degrees in the reflection angles. This extension is due to the surfaces having an inclination angle greater than or equal to 22.5 degrees (half of 45 degrees). Namely, in this example, concave inner surface 22R includes an inclination angle greater than or equal to half of the expected incident angle of the ambient light or the sunlight.

The user generally looks into the display from a position approximately right in front of the display (normal to the display surface) or looks down from a position slightly higher than the above-mentioned position. Therefore, the extension of the peak of the light reflection intensity about the normal direction (as indicated in FIG. 6) improves the visibility of display devices during outdoor use with the display surface held substantially vertical.

FIG. 7 is a schematic cross-sectional view of the semi-transparent type liquid crystal display of the second embodiment.

As for the semi-transparent type liquid crystal display 3 of the second embodiment, the reflection board 6 of the first embodiment is replaced by a reflection board 6A that is semi-transparent and a backlight 30 that is provided behind the glass substrate 4. However, the other structures are the same as those described in the first embodiment. Each area corresponding to a pixel of the display 3 of the semi-transparent reflection board 6A has a reflecting area and a transmitting area. The reflecting area may include aluminum (Al), silver (Ag), or an alloy including aluminum and/or silver. The light-transmitting area may include ITO (Indium Tin Oxide).

Incidentally, although in the present embodiment the sectional profile of each first and second inclination is given as a single continuous smooth curve, each profile may also include a plurality of linear or curved segments. The inclinations of neighboring two segments in the profile may be either continuous or discontinuous at the connection point. Furthermore, in the present embodiment, although the inclinations of the first inclination profile and the second inclination profile are discontinuous at their connecting point, they could also be continuous. In such case, the boundary between the first and second inclinations may be defined at the bottom of the entire profile.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2008-065817 (filed on Mar. 14, 2008) which is expressly incorporated herein, by reference, in its entirety.

1. A display comprising:
a reflection board that includes a plurality of first inclinations and a plurality of second inclinations which are alternately arranged to form an uneven reflective surface to reflect and diffuse incident light; and
a display element with controllable transparency at each pixel, disposed in front of said reflective surface;
the mean inclination angle of said first inclination being set within a range of 10 to 25 degrees.

2. A display according to claim 1, wherein the absolute value of the mean inclination angle of said first inclination is smaller than that of said second inclination.

3. A display according to claim 1, wherein the area of said first inclination is larger than the area of said second inclination.

4. A display according to claim 1, further comprising a backlight disposed on the side opposite said reflective surface, said reflection board being of the semi-transparent type.

5. A display according to claim 1, wherein said display element comprises liquid crystal.

6. A reflection board for a display comprising:
a plurality of first inclinations and a plurality of second inclinations which are alternately arranged to form an uneven reflective surface to reflect and diffuse incident light;
the mean inclination angle of said first inclination occurring within a range of 10 to 25 degrees.
